(19) United States
(12) Patent Application Publication
(10) Pub. No.: US 2022/0194146 A1
(43) Pub. Date: Jun. 23, 2022

(54) PNEUMATIC TIRE WITH SEALANT

(71) Applicant: The Goodyear Tire & Rubber Company, Akron, OH (US)

(72) Inventors: Jean-Claude Patrice Philippe Griffoin, Mertzig (LU); Sameer Gupta, Hanau (DE); Moritz Brückner, Mömbris (DE); Roman Goerl, Obernburg am Main (DE); Kevin Erik M Pierret, Bastogne (BE)

(21) Appl. No.: 17/548,800

(22) Filed: Dec. 13, 2021

Related U.S. Application Data
(60) Provisional application No. 63/127,671, filed on Dec. 18, 2020.

(51) Int. Cl. B60C 19/12; B60C 3/04; B60C 11/03; B60C 9/22

(52) U.S. Cl. CPC B60C 19/122; B60C 9/22; B60C 11/0306; B60C 3/04

(57) ABSTRACT

The present invention is directed to a pneumatic tire comprising a tread portion having (i) circumferential grooves and (ii) circumferential ribs or rows of tread blocks; an inner surface defining a tire cavity; and a sealant material layer at least partially covering the inner surface radially below the tread portion within the tire cavity. The sealant material layer comprises elevations of sealant material, wherein an elevation of sealant material is provided radially below each of at least two of the circumferential grooves, and wherein the sealant material layer has a larger radial thickness in said elevations than in areas radially below the circumferential ribs or rows of tread blocks.

This application claims benefit of U.S. Provisional Patent Application Ser. No. 63/127,671, filed on Dec. 18, 2020. The teachings of U.S. Provisional Patent Application Ser. No. 63/127,671 are incorporated herein by reference in their entirety.

### FIELD OF THE INVENTION

This invention specifically relates to a pneumatic tire, in particular a pneumatic tire having on its interior surface a sealant layer, optionally carrying at least one foam element.

### BACKGROUND OF THE INVENTION

Self-sealing pneumatic tires typically retard or prevent the loss of air pressure and consequential deflation of the tire after it has been punctured with a sharp object, such as a nail or screw. A plurality of methods, sealants, and tire constructions have been described in the prior art for puncture sealant pneumatic tires. However, most of these approaches have had certain drawbacks.

While the sealant helps in many cases to efficiently seal a puncture, it often results in additional weight and heat build-up and isolation. This may result in undesirable ride characteristics and reduced handling performance and/or undesirable heat distributions in the tire. Such drawbacks may be even more relevant if an additional noise dampening element is attached to a radially inner side of the sealant material layer. In particular, such a noise dampening element may even further negatively impact temperature distribution in the tire.

Moreover, the attachment of a noise dampening element on sealant material may negatively impact the sealing performance of the sealant material due to an interaction with the noise dampening element.

It would therefore be desirable to provide an improved tire having a good sealant performance and/or limited heat build-up as well as low noise generation resulting from tire cavity resonance.

### SUMMARY OF THE INVENTION

A first object of the present invention may be to provide an advanced pneumatic tire having self-sealing properties.

Another object of the present invention may be to provide an advanced pneumatic tire with a sealant material layer supporting improved ride and handling properties.

Another object of the present invention may be to provide an advanced pneumatic tire having improved high speed properties and/or improved temperature behavior, in particular at high speeds.

Another object of the present invention may be to provide a sealant tire with limited weight, and preferably with limited tire cavity noise.

Still another object of the present invention may to provide a cost-efficient sealant tire, in particular with decent sound dampening and sealing properties.

The present invention is defined by independent claim 1. Further preferred embodiments are defined by the dependent claims and in the summary and description herein below.

Thus, in a first aspect of the invention, a pneumatic tire is provided, said tire comprising a tread portion having i) circumferential grooves and ii) circumferential ribs or rows of tread blocks; optionally two bead portions and two sidewalls extending between the tread portion and the respective bead portion(s); an inner surface defining a tire cavity; and a sealant material layer at least partially or fully covering the inner surface radially below the tread portion within the tire cavity. The sealant material layer comprises elevations of sealant material, wherein an elevation of sealant material is provided radially below each of at least two of the circumferential grooves, and wherein the sealant material layer has a larger radial thickness in said elevations than in areas radially below the circumferential ribs or rows of tread blocks.

The arrangement of the sealant material in accordance with the present invention helps to reduce heat build-up under the relatively thick tread ribs or tread blocks whereas the sealant material thickness is larger below at least two of the circumferential grooves (optionally below all circumferential grooves), in particular the circumferential main grooves. In the area of said grooves, the tread has less rubber material than in the areas below ribs or rows of tread blocks such that heat build-up is limited in these areas below the grooves. As rubber thickness radially below the grooves is relatively thin, these portions may also be punctured more easily than areas of larger rubber thickness such as below the tread ribs. The larger sealant material layer thickness below the grooves helps to mitigate the higher risk of puncture in these groove areas. It would be less desirable to provide a relatively thick sealant layer over the whole axial width of the tread as this would result in a higher heat build-up under the whole tread portion.

In one embodiment, each elevation (or in other words ridge) has an axial width within a range of 70% to 130% of an axial width of a bottom of a circumferential groove radially above the respective elevation. Thus, an, or one, elevation covers at least a substantial axial width of the groove radially above or outside the elevation. In particular, it is less desirable to have a smaller or larger width as this would either impair sealability or heat conductivity.

In another embodiment, an elevation of the sealant material is provided radially below each of said circumferential grooves. Such an arrangement provides the positive effects of the invention for all circumferential grooves.

In one embodiment, the pneumatic tire comprises at least two (preferably at least three, more preferably at least four or even more preferably at least five) circumferential grooves and at least three (preferably at least four, more preferably at least five, or even more preferably at least six) circumferential ribs or rows of tread blocks. The circumferential grooves can also be described as circumferential main grooves.

In another embodiment, said elevations extend circumferentially over at least 95% of the inner circumference or surface of the tire (in particular, at the axial position of the respective elevation).

In another embodiment, the largest radial thickness of the elevations is within a range of 3 mm to 9 mm (preferably 3 or 4 mm to 8 mm), measured from the inner surface of the tire to the radially innermost surface of the respective elevation. In general, the radially inner surface, or in other words interior surface, is preferably formed by an inner liner of the tire.

In still another embodiment, a radial thickness of the sealant material layer is, at an axial position in the middle between two neighboring elevations, within a range of 2 mm to 6 mm, (preferably 3 mm to 5 mm). Two neighboring elevations are understood as axially neighboring elevations unless indicated otherwise herein.

In yet another embodiment, a radial thickness of the sealant material layer between two neighboring elevations is on average within a range of 2 mm to 6 mm. In particular, it is possible that the sealant material surface has a certain roughness, e.g. caused by the manufacturing method, such as the application of sealant material strips.

In still another embodiment, a difference between i) a radial thickness of the sealant material layer in the middle between two neighboring elevations (or an average of the radial thickness of the sealant material between two neighboring elevations) and ii) a largest radial thickness of one of the neighboring elevations is at least 0.5 mm, preferably at least 0.8 mm, or even more preferably at least 1 mm or yet more preferably at least 1.5 mm. In addition, or alternatively, said difference may be at most 3 mm, preferably at most 2 mm or at most 1.6 mm. If two neighboring elevations have different largest radial thicknesses, the elevation having the smaller largest radial thickness is considered herein.

In still another embodiment, the sealant material layer extends over at least 90% of the width of said tread portion or tread, measured in an axial direction of the tire. In a further another embodiment, the tire comprises a belt portion radially below the tread portion, said belt portion comprising multiple belt plies arranged radially on top of one another, and wherein the sealant material layer extends over at least 95% of the width, measured in an axial direction, of the axially largest belt ply.

In still another embodiment, a radial thickness of an elevation of two neighboring elevations, measured from the inner surface of the tire (e.g. the inner liner) to the radially innermost surface, or tip of the respective elevation, is one or more of:

(i) at least 15% larger, preferably at least 20% larger, than a radial thickness of the sealant material layer in the middle between the two neighboring elevations or the average radial thickness between these neighboring elevations; and

(ii) at most 100%, preferably at most 50%, larger than a radial thickness of the sealant material layer in the middle between the two neighboring elevations or than an average radial thickness of the sealant material layer between said neighboring elevations. In particular, very thick sealant material areas may be less desirable, even at the position of the grooves.

For instance, said radial thickness of the elevations can be 15% to 100%, 20% to 90%, 30% to 80% greater, or 40% to 70% greater than the radial thickness of the sealant material layer in the middle between the two neighboring elevations or the average radial thickness between these neighboring elevations.

In still another embodiment, the sealant material layer comprises one of:

(i) axially adjacent sealant material strips extending essentially circumferentially (i.e. with an angle of 0° to 0.5° or 0° with respect to the equatorial plane of the tire) about an axis of the tire and along the inner surface of the tire (e.g. on the inner liner of the tire), and

(ii) one or more sealant material strips spirally (e.g. with an angle smaller than 5° or even smaller than 2° with respect to the equatorial plane of the tire) wound about an axis of the tire and along the inner surface, e.g. the inner liner, of the tire.

In particular, such a sealant layer is efficiently applicable to a tire after cure of the tire.

In still another embodiment, the sealant material strips form the elevations and/or the areas of the sealant material layer radially below the circumferential ribs or rows of tread blocks, and wherein the sealant material strips are optionally one or more of:
radially thicker in areas radially below the circumferential grooves than in the areas radially below the circumferential ribs or rows of tread blocks so as to form the elevations in the sealant material layer; and
preferably at least in the elevations, arranged on top of one another other so as to form at least the elevations in the sealant material layer.

Thus, it is possible that sealant material strips, or in other words beads, are only arranged on top of one another in the elevations. It is also possible that areas between two neighboring elevations comprise multiple layers of strips arranged on top of one another in radial direction. In such a case, the elevations can typically have even more layers of strips of sealant material.

In another embodiment, a sealant material strip could for instance have one of an essentially rectangular cross section, an essentially polygonal cross section, an essentially circular cross section and an essential ellipsoidal cross section.

In still another embodiment, the largest radial thickness of a sealant material strip corresponds to the largest radial thickness of an elevation so as to form the elevation in the sealant material layer.

In still another embodiment, the sealant material layer comprises sealant material strips with different radial thickness, such as strips having the radial height of the elevations and strips having a smaller radial height than the strips forming the elevations so as to form the areas of the sealant material layer between the elevations.

In still another embodiment, the elevations have an axial width within a range of 80% to 120%, preferably 90% to 110%, of the axial width of the bottom of the respective grooves radially above the elevations.

In another embodiment, each elevation is essentially axially centered with respect to the axial center of a bottom of the respective groove arranged radially above the elevation.

In still another embodiment, the tread portion has two shoulder portions and a middle or center portion arranged axially between the two shoulder portions, wherein each shoulder portion comprises a circumferential shoulder rib or circumferential row of shoulder tread blocks. In addition, or alternatively, the center portion comprises at least three circumferential ribs and at least four circumferential grooves. Each shoulder rib may optionally be delimited by one of the at least four circumferential grooves, in particular by a respective axially outermost circumferential groove. Such arrangements of ribs and grooves are typically found in relatively broad high performance tires, in particular UHP summer tires.

In still another embodiment, i) the elevations in the sealant material layer and ii) areas of the sealant material layer having a radial thickness smaller than the radial thickness of said elevations alternate along an axial direction of the tire. Preferably, the tire has at least 3 of said areas and four of such elevations alternatingly arranged along the axial direction.

In an embodiment, the sealant material layer has, viewed in an axial direction, at least 3 elevations formed between adjacent areas of sealant material having a smaller radial thickness than said elevations. The areas of sealant material axially between two adjacent elevations may also be generally described as valleys in the sealant material layer.

In still another embodiment, said areas of the sealant material layer having a radial thickness smaller than the radial thickness of said elevations have an axial width within a range of 60% to 120% of the radially outermost surface of the respective rib or respective row of tread blocks radially above.

In still another embodiment, the sealant material is one or more of: a butyl rubber-based composition, a polyisoprene-based composition, a natural rubber-based composition, a polyurethane-based composition, a polybutene-based composition, an emulsion styrene-butadiene rubber-based composition, an EPDM-based composition, and a silicone-based composition. For instance, the sealant material can be a blend of butyl rubber and polyisobutylene as described in U.S. Pat. No. 4,895,610. The teachings of U.S. Pat. No. 4,895,610 are incorporated herein by reference for the purpose of describing such blends of and the method by which they can be incorporated into a tire. In another embodiment, the sealant material can be comprised of expanded solids comprising expandable graphene structures and microspheres as described by U.S. Pat. No. 9,802,446. The teachings of U.S. Pat. No. 9,802,446 are incorporated herein by reference for the purpose of describing such sealant materials. The sealant material composition can in another embodiment be comprised of at least one non-halogenated butyl rubber and 2,2′-dibenzamido-diphenyldisulfide, the sealant material composition having a viscosity that permits the sealant material composition to be incorporated into a tire during a tire building process and to degrade to a lower viscosity that permits the resulting degraded sealant material composition to flow into and seal a puncture in a tire. This sealant composition is described in greater detail in United States Patent 8,360,122. The teachings of U.S. Pat. No. 8,360,122 are incorporated herein by reference for the purpose of describing such sealant compositions

In another embodiment, a foam element (or in other words a foam member, such as a circumferentially extending foam strip) is attached to a radially inner surface of at least two neighboring elevations such that at least one air cavity is formed between said neighboring elevations, a radially outer surface of the foam element (e.g. said foam strip) and the surface of the sealant material layer between said neighboring elevations. In particular, it has been found that the presence of a foam element such as a foam block or circumferentially extending foam strip on a sealant material layer may negatively affect the flow and/or sealant properties of the sealant material in case of puncture. Moreover, the presence of the foam results in a decreased heat conductivity towards the tire cavity and thus potentially in a heat build-up. The attachment of the foam element (such as block or circumferentially extending strip) to neighboring elevations helps to mitigate said drawbacks.

In another embodiment, multiple foam blocks are arranged along the circumferential direction of the tire.

In still another embodiment, the foam element is at least one foam strip continuously or discontinuously extending along a circumferential length which corresponds to at least 50%, preferably at least 80%, of an inner circumference of the tire measured along the inner surface at an axial center of the tire.

In still another embodiment, the foam strip extends about the (center) axis of the tire.

In still another embodiment, the axial width of the foam element (e.g. a foam block or foam strip) is within a range of 20% to 50% of a maximum axial width of the sealant material layer. The tire may have multiple foam elements such as said strips or blocks. In particular, it may be desirable to a have a limited axial width of the foam elements in order to avoid unnecessary heat build-up in a region of the tire to which the foam element is attached. In general, the foam elements, in particular the foam strips could have polygonal, e.g. rectangular, cross-sections in non-limiting examples.

In still another embodiment, the foam element has an axial width which is larger than the distance between two neighboring elevations to which the foam element is attached.

In still another embodiment, the foam element has a radially inner portion which has a larger axial width than a radially outer portion or outermost surface attached to two neighboring elevations. Such an embodiment provides a relatively large volume of foam with a limited surface close to the sealant material layer.

In another embodiment, the axial width of each elevation is smaller than 50%, preferably smaller than 30%, or even smaller than 20%, of the axial width of the foam element, such as the circumferential foam strip.

In still another embodiment, the foam element, in particular the strip or block is free of a coating or foil facing the sealant material layer.

In another embodiment, the foam element comprises (or consists of) one or more of: a noise dampening material; a porous material; a polymeric foam material; a polyurethane foam material; a material having a density within a range of 0.01 g/cm³ to 1 g/cm³. The terms damping and dampening are used interchangeably herein.

In another embodiment, the foam element comprises or consists of a porous material and/or one or more of the following materials: polyurethane foam (e.g. polyether-urethanes, polyester-urethanes), melamine foam, polypropylene foam, foamed rubber (e.g. EPDM, Neoprene based foams), natural material-based foam (e.g. cellulose, chitosan-based foams), non-woven material (e.g. felt from melt-blown, spun laid or electro spun or natural fiber of polyester, polyamide, PE, PET, PP, cellulose, cotton, wool or silk). In addition, or alternatively, the foam element comprises or consists of one or more of the following: polyurethane foam, polyethylene foam, foam rubber, and the like. Suitable polyurethane foams are typically made by the polymerization of a diisocyanate and a polyol in the presence of a suitable blowing agent. A wide variety of rubber foams can be utilized in the practice of this invention with natural rubber, synthetic polyisoprene rubber, polybutadiene rubber, nitrile rubber, and styrene-butadiene rubber foams being commonly used. Such foam rubbers are typically made by foaming a natural or synthetic rubber latex with a chemical foaming agent. The chemical foaming agent will typically be an azo compound, such as azodicarbonamide, a hydrazine compound, a carbazide, a tetrazole, a nitroso compound, and/or a carbonate, such as sodium bicarbonate.

In still another embodiment, one or more foam strips are arranged (preferably essentially in parallel) along the circumferential direction. The provision of multiple strips may reduce the size of continuous regions covered by noise dampening material and may thus reduce heat build-up in the tire radially above the strips.

In another embodiment, the foam element is made of open cell foam material. Preferably such material comprises from 55% to 95% (or preferably from 60% to 90%) open cells (of all cells) in the material. An open cell can be understood as a cell having at least one aperture. In other words, open cells are not fully closed or not fully enclosed by a cell wall. Closed cell foam does not fall into the above range as most cells of this foam type are closed. Fully or almost fully reticulated foam does not fall under that range either as it has almost no walls and constitutes rather an open grid. Whether cells are open or not (i.e. closed) can for instance be determined by light microscopy, SEM or NMR. Cell sizes could typically range from 10 μm to 1 mm (maximum diameter).

In another embodiment, the foam is adapted and/or used for dampening tire cavity noise, in particular in the range from 100 Hz to 300 Hz or in the range from 100 Hz to 200 Hz or from 200 Hz to 300 Hz. The term tire cavity, as mentioned herein, shall be the volume enclosed by the inner surface of the tire (or, if present, by the inner liner of the tire), especially in an unmounted and uninflated state, and closed by an (imaginary) circumferential ring-shaped plane contacting the radially innermost edges of both bead portions.

In still another embodiment, the foam element adheres (directly) to the sealant material. In other words, the interface between sealant material and foam element is free of additional adhesives or glues. It is rather the stickiness of the sealant material which holds the foam element in place.

In another aspect of the present invention, a method of manufacturing a pneumatic tire is provided, preferably the pneumatic tire according to the preceding aspect or one or more of its embodiments, the method comprising one or more of the following steps:
a) Providing an uncured pneumatic tire, comprising a tread portion, and optionally two bead portion and two sidewalls connecting the respective bead portion with the tread portion, wherein the tread portion has multiple circumferential grooves;
b) Curing the tire;
c) Forming a sealant material layer on an inner surface (e.g. on an inner liner) of the cured tire by applying one or more sealant material strips onto said inner surface, and forming elevations in the sealant material layer in areas radially below (or in other words radially inside of) the circumferential grooves of the tread portion;
d) Attaching to the radially innermost portion of two neighboring elevations at least one foam element.

In one embodiment, the sealant material layer is formed by applying one or more sealant material strips spirally about an axis of the tire and along the inner surface of the tire.

In another embodiment, the step of forming the sealant material layer comprises rotating the tire about its rotation axis and extruding the sealant material strips onto the rotating inner surface of the tire.

In still another embodiment, the strips are extruded by an extrusion head and/or die which is movable or moved in an axial direction relatively to the tire during extrusion of the sealant material strips. Together with said rotation of the tire, circumferential or spiral strips may be applied to the inner surface of the tire.

In another embodiment, the sealant material layer is formed by applying (at the same time or subsequently) axially adjacent sealant material strips extending circumferentially about an axis of the tire and along the inner surface of the tire.

In still another embodiment, said strips are extruded or applied with a larger thickness when forming an elevation.

In still another embodiment, multiple layers of strips (in particular 2 or 3 layers) are arranged on top of each other at least in the elevations.

In still another embodiment, the sealant material strips have an axial width within a range of 2 mm to 15 mm, preferably 5 mm to 12 mm, more preferably 7.5 mm to 12 mm, and most preferably 8 mm to 15 mm.

In still another embodiment, the larger thickness of sealant material in the elevations is provided by one or more of: extruding the sealant material strips with higher speed than in regions having smaller radial thickness; extruding the sealant material strips with higher pressure than in the regions having smaller radial thickness; using (extrusion) dies with larger outlet diameters; using extrusion dies with adjustable, in particular enlargeable, outlet diameters; rotating the tire slower about its rotation axis when extruding the strips in the elevations than when extruding the strips in regions with smaller radial thickness.

The above described application of sealant material strips is of particular interest in combination with foam strips or in other words noise dampening foam strips, essentially extending in a circumferential direction.

In still another embodiment, the method further comprises a step of applying a first layer of one or more sealant material strips over the total axial width of the sealant material layer and a further step of applying at least a second layer (discontinuously or continuously) of one or more sealant material strips, wherein the second layer of sealant material strips forms the elevations of sealant material.

In an embodiment, the tire is a passenger car tire, a truck tire or a bus tire.

In another embodiment, the tire has at least a width of 225 mm, preferably at least of 245 mm.

In yet another embodiment the tire is a summer tire.

In another embodiment, the tire is an all season tire, optionally showing the 3 peak mountain snow flake symbol (3PMSF symbol) on at least one sidewall.

In another embodiment the tire is a winter tire showing the 3 peak mountain snow flake symbol (3PMSF symbol) on at least one sidewall.

In general, the features of different aspects and embodiments of the invention as well as of the below description can be combined with one another.

### BRIEF DESCRIPTION OF THE DRAWINGS

The structure, operation and advantages of the invention will become more apparent upon contemplation of the following description taken in conjunction with the accompanying drawings, wherein:

FIG. 1 shows a schematic cross section of a prior art tire comprising a sealant material layer;

FIG. 2 shows a schematic cross section of an embodiment of a sealant tire in accordance with the present invention;

FIG. 3 shows a schematic cross section of a prior art tire comprising a foam material strip attached to a sealant material layer; and

FIG. 4 shows a schematic cross section of a noise dampened sealant tire in accordance with an embodiment of the present invention.

### DETAILED DESCRIPTION OF THE EMBODIMENTS

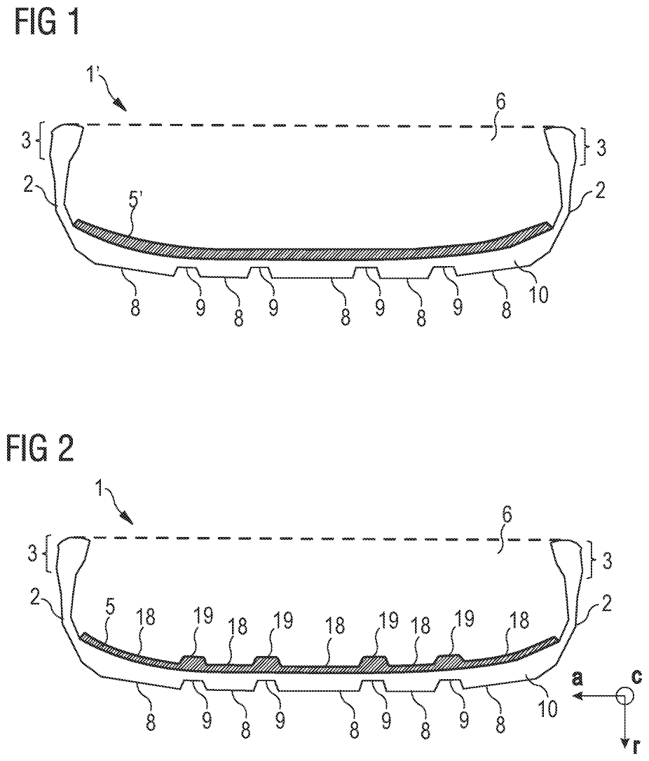

FIG. 1 is a schematic cross-section of a tire 1′ in accordance with the prior art. The example tire 1′ has a tread portion 10, two bead portions 3, and two sidewalls 2 joining outer axial edges of the tread portion 10 with the respective bead portions 3. The tread portion 10 has a plurality of circumferential grooves 9 and ribs 8. Such pneumatic tire constructions are generally known in the tire art. The tire 1′ has an inner surface defining a tire cavity 6. A sealant material layer 5′ is provided on the inner side or surface of the tire 1′ in an area opposite to the tread portion 10. The thickness of the sealant material layer 5′ is essentially constant over the axial width and circumference of the tire F. For the sake of an improved intelligibility, reference signs (numerals) 2, 3, 6, 8, 9, and 10 are used for the same elements as described herein below in the description of FIGS. 2 to 4.

FIG. 2 shows a tire 1 in accordance with a first embodiment of the present invention. Similar to the tire 1′ shown in FIG. 1, tire 1 has sidewalls 2, bead portions 3, a tread portion 10, a tire cavity 6, optionally delimited by an inner liner of the tire 1, circumferential grooves 9 (or in other words circumferential main grooves) as well as circumferential ribs 8.

The sealant material layer 5 according to the embodiment shown in FIG. 2, extends in a circumferential direction c and in an axial direction a along the inner surface of the tire 1. The sealant material layer 5 has four elevations 19, wherein each elevation 19 is axially positioned radially below a groove 9. In other words, the sealant material layer 5 has thicker portions at the axial positions of the grooves 9 than in areas of smaller radial thickness 18 arranged at axial positions radially below the ribs 8. As a consequence, the thicker sealant material in areas radially inside of the grooves, improves the sealing performance of the tire 1 in areas where the tread rubber material is relatively thin compared to the areas of relatively thick tread rubber material at the axial position of the ribs 8. This arrangement provides an advanced compromise between sealability and weight impact of the sealant material. In particular, large amounts of sealant material result in a higher weight of the tire 1 and can thus lead to inferior ride and handling properties. Cost efficiency is improved as well compared to the tire 1′ as shown in FIG. 1. In addition, the fact of having a sealant material thickness which is smaller in the areas radially below the ribs 8 improves heat conductivity and/or avoids heat build-up in these areas, in particular for improved high speed performance and frequent cornering maneuvers. It is noted that the relative thickness of the depicted elevations 19 or in other words protrusions or ridges of sealant material in the radially inner direction is shown in FIG. 1 schematically. Preferable absolute and relative thickness values have been mentioned herein above. In a non-limiting embodiment, the thickness of the sealant material layer 5 is about 3.6 mm in areas 18 between the elevations 19 whereas the largest thickness of the sealant material layer 5 in the elevations 19 is about 4.5 mm.

For the sake of better comprehensibility, the axial direction a, the circumferential direction c and the radial direction r have been indicated in FIG. 2 as commonly used in the description of tire geometries. The term direction shall not be limited to a certain orientation unless otherwise indicated herein. An axial direction a may be understood as a direction in parallel to the rotation axis of the tire 1. The circumferential direction c is concentric to the rotation axis of the tire 1 and the radial direction r extends radially from the latter as commonly understood in the tire art.

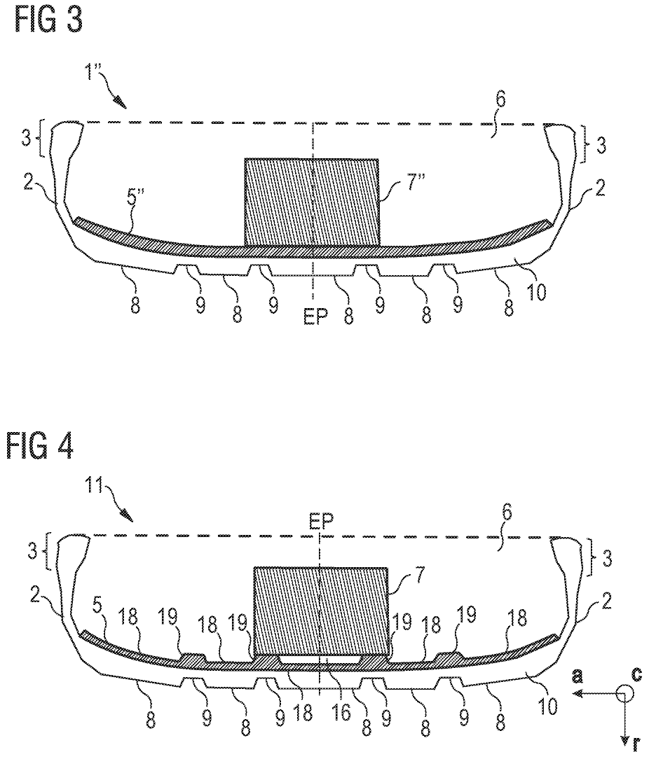

FIG. 3 shows a prior art tire 1″ with elements 2, 3, 6, 8, 9, 10 as already described in relation to FIGS. 1 and 2 above, but includes a sealant material layer 5″ carrying a noise dampening element 7″. Such a noise dampening element 7″ may be used to dampen or reduce the noise generated in the tire cavity 6 when driving. A drawback of such an arrangement consists in a relatively large heat build-up radially above the noise dampening element 7″ which is acting together with the sealant material layer 5″ as a thermal insulator. This may negatively impact tire performance and/or stability. Moreover, it has been found that such noise dampening elements 7″ may negatively affect the performance of the sealant material by hindering the free flow of the sealant material into a puncture hole in the tread. Therefore, such an arrangement typically requires a relatively thick sealant material layer 5″ which has again a negative impact on costs, weight and heat conductivity, and therefore also on tire performance.

According to the preferred embodiment of the invention, in the form of a tire 11 as shown in FIG. 4, using again same reference signs as in the previously discussed Figures where applicable, a foam element, such as a circumferential foam strip 7 is attached to a sealant material layer 5. The sealant material layer 5 has, by way of non-limiting example, the same shape as in the embodiment of FIG. 2 so that it comprises elevations 19, radially below the grooves 9 and areas of smaller sealant material thickness 18 radially below the ribs 8. The foam strip 7 is attached to two elevations 19 so as to form an air cavity 16 between the sealant material layer 5 and the foam strip 7. Thus, the foam strip 7 is not directly contacting the sealant material layer 5 over its whole axial width. Heat build-up below the foam strip and also in the area of the ribs is reduced. Moreover, sealant material flow into puncture holes radially above the foam strip 7 is ensured due to relatively large sealant material thickness in positions where the sealant material contacts the foam strip 7 and due to the air cavity 16 in an area between the two neighboring elevations 19 covered by the foam strip 7. In addition, the relatively large sealant material thickness radially below the circumferential main grooves 9 provides an improved security feature. Sealant material is saved in the areas 18 so as to reduce overall weight and improve heat conductivity.

While a foam strip 7 has been described in this embodiment as one example of a foam element, it is also possible that multiple foam strip segments are provided behind each other in the circumferential direction or multiple foam blocks are provide along the circumferential direction and attached to at least two axially neighboring elevations.

It is preferred that foam elements such as the circumferential foam strip 7 are positioned at an axial center of the tire 11 or in other words along the equatorial plane EP of the tire 11 as shown in FIG. 4. Such an arrangement improves tire balance.

While certain representative embodiments and details have been shown for the purpose of illustrating the subject invention, it will be apparent to those skilled in this art that various changes and modifications can be made therein without departing from the scope of the subject invention.

What is claimed is:

1. A pneumatic tire comprising a tread portion having (i) circumferential grooves and (ii) circumferential ribs or rows of tread blocks; an inner surface defining a tire cavity; and a sealant material layer at least partially covering the inner surface radially below the tread portion within the tire cavity, the sealant material layer comprising elevations of sealant material, wherein an elevation of sealant material is provided radially below each of at least two of the circumferential grooves, and wherein the sealant material layer has a larger radial thickness in said elevations than in areas radially below the circumferential ribs or rows of tread blocks.

2. The pneumatic tire according to claim 1, wherein each elevation has an axial width within a range of 70% to 130% of an axial width of a bottom of a circumferential groove radially above the respective elevation.

3. The pneumatic tire according to claim 1, wherein a radial thickness of an elevation of two neighboring elevations, measured from the inner surface of the tire to the radially innermost surface of the respective elevation, is one or more of:
at least 15% larger than a radial thickness of the sealant material layer in the middle between the two neighboring elevations; and
at most 100% larger than a radial thickness of the sealant material layer in the middle between the two neighboring elevations.

4. The pneumatic tire according to claim 1, the tire comprising at least three circumferential grooves and at least four circumferential ribs or rows of tread blocks.

5. The pneumatic tire according to claim 1, wherein an elevation of the sealant material is provided radially below each of said circumferential grooves.

6. The pneumatic tire according to claim 1, wherein the largest radial thickness of the elevations is within a range of 3 mm to 9 mm, measured from the inner surface of the tire to the radially innermost surface of the respective elevation.

7. The pneumatic tire according to claim 1, wherein a radial thickness of the sealant material layer in the middle between two neighboring elevations is within a range of 2 mm to 6 mm.

8. The pneumatic tire according to claim 1, wherein a difference between i) a radial thickness of the sealant layer in the middle between two neighboring elevations and ii) a largest radial thickness of one of the neighboring elevations, is at least 0.5 mm.

9. The pneumatic tire according to claim 1, wherein the sealant material layer extends in an axial direction over at least 90% of the width of said tread portion.

10. The pneumatic tire according to claim 1, wherein the sealant material comprises one or more of: a butyl rubber-based composition, a polyisoprene-based composition, a natural rubber-based composition, a polyurethane-based composition, a polybutene-based composition, an emulsion styrene-butadiene rubber-based composition, an EPDM-based composition, and a silicone-based composition.

11. The pneumatic tire according to claim 1,
wherein the sealant material layer comprises one of:
(i) axially adjacent sealant material strips extending circumferentially about an axis of the tire and along the inner surface of the tire, and
(ii) one or more sealant material strips spirally wound about an axis of the tire and along the inner surface of the tire.

12. The pneumatic tire according to claim 11, wherein the sealant material strips form the elevations and the areas of the sealant material layer radially below the circumferential ribs or rows of tread blocks, and wherein at least multiple sealant material strips are one or more of:
radially thicker in areas radially below the circumferential grooves than in the areas radially below the circumferential ribs or rows of tread blocks so as to form the elevations in the sealant material layer;
arranged on top of one another so as to form the elevations in the sealant material layer.

13. The pneumatic tire according to claim 1, wherein the tread portion has two shoulder portions and a center portion axially between the two shoulder portions, and wherein each shoulder portion comprises a circumferential shoulder rib or row of shoulder tread blocks, and the center portion comprises at least three circumferential ribs and at least four circumferential grooves, and wherein each shoulder rib is delimited by one of the at least four circumferential grooves.

14. The pneumatic tire according to claim 1, wherein the elevations in the sealant material layer and areas of the sealant material layer having a radial thickness smaller than the radial thickness of said elevations alternate along an axial direction of the tire.

15. The pneumatic tire according to claim 1, wherein said areas of the sealant material layer having a radial thickness smaller than the radial thickness of said elevations have an axial width within a range of 60% to 120% of the radially outermost surface of the respective rib or respective row of tread blocks radially above.

16. The pneumatic tire according to claim 1, wherein at least one foam element is attached to a radially inner surface of at least two axially neighboring elevations such that at least one air cavity is formed between said axially neighboring elevations, a radially outer surface of the foam element and a radially inner surface of the sealant material layer between said axially neighboring elevations.

17. The pneumatic tire according to claim 16, wherein the foam element is a foam strip extending in a circumferential direction along a circumferential length corresponding to at least 50%, preferably at least 80%, of an inner circumference of the tire, measured along the inner surface at an axial center of the tire.

18. The pneumatic tire according to claim 16, wherein the axial width of the foam element is within a range of 20% to 50% of a maximum axial width of the sealant material layer.

19. The pneumatic tire according to claim 16, wherein the foam element is free of a coating or foil facing the sealant material layer.

20. The pneumatic tire according to claim 16, wherein the foam element comprises one or more of:
a noise dampening material;
a polymeric foam material;
a polyurethane foam material;
a strip shape; and
a material having a density within a range of 0.01 g/cm³ to 1 g/cm³.
